(19) United States
(12) Patent Application Publication
(10) Pub. No.: US 2023/0273733 A1
(43) Pub. Date: Aug. 31, 2023

(54) IN-MEMORY COMPUTE CORE FOR MACHINE LEARNING ACCELERATION

(71) Applicant: Intel Corporation, Santa Clara, CA (US)

(72) Inventors: Sagar Varma Sayyaparaju, Hyderabad (IN); Pramod Udupa, Bangalore (IN); Dinesh Kushwaha, Bangalore (IN)

(73) Assignee: Intel Corporation, Santa Clara, CA (US)

(21) Appl. No.: 18/312,289

(22) Filed: May 4, 2023

(51) Int. Cl. G06F 3/06

(52) U.S. Cl. CPC G06F 3/0625; G06F 3/0644; G06F 3/0659; G06F 3/0673

(57) ABSTRACT

Systems and methods include technology that receives, with a plurality of cores implemented in one or more of configurable logic or fixed-functionality logic, data associated with a workload, and executing, with the plurality of cores, the workload to process the data and generate partial data. The technology stores the partial data into a memory storage that is accessible by the plurality of cores as the workload is being executed.

### TECHNICAL FIELD

Examples generally relate to in-memory compute core (IMCC) architectures. In particular, examples include an intra-memory data reuse scheme for storing partial sums in an IMCC during compute operations executed by the IMCC.

### BACKGROUND

Machine learning (e.g., neural networks, deep neural networks, etc.) workloads may include a significant amount of operations. For example, machine learning workloads may include numerous nodes that each execute different operations. Such operations may include General Matrix Multiply operations, multiply—accumulate operations, etc. The operations may consume memory and processing resources to execute.

### BRIEF DESCRIPTION OF THE DRAWINGS

The various advantages of the embodiments will become apparent to one skilled in the art by reading the following specification and appended claims, and by referencing the following drawings, in which:

FIG. 1 is an example of an existing example of a computational system and enhanced IMCC architecture according to an embodiment;

FIG. 2 is a flowchart of an example of a method of operating an IMCC according to an embodiment;

FIG. 3 is an example of a detailed circuit diagram of local storage of partial sums inside an IMCC according to an embodiment;

FIG. 4 is an example of a block diagram of an enhanced IMCC according to an embodiment;

FIG. 5 is an example of a detailed diagram of read/write accesses according to an embodiment;

FIG. 6 is a block diagram of an example of an IMCC according to an embodiment;

FIG. 7 is an example of a block diagram of a processing array according to an embodiment;

FIG. 8 is a diagram of an example of a memory enhanced computing system according to an embodiment;

FIG. 9 is an illustration of an example of a semiconductor apparatus according to an embodiment;

FIG. 10 is a block diagram of an example of a processor according to an embodiment; and

FIG. 11 is a block diagram of an example of a multi-processor based computing system according to an embodiment.

### DESCRIPTION OF EMBODIMENTS

Compute-in-Memory (CIM) architectures may closely relate the processing and storage capabilities of a computer system into a single, memory-centric computing structure. In CIM, computations may be performed directly in memory rather than moving data between the memory and a computation unit or processor. CIMs may accelerate machine learning workloads such as artificial intelligence (AI)/deep neural networks (DNN) workloads. The mapping of workloads onto hardware (e.g., CIMs) plays a crucial role in defining the performance and energy consumption in such applications. CIMs may also be referred to as IMCCs.

A “weight stationary” dataflow may be adopted and stores weights into a memory location and stays stationary for further accesses. That is, the weights stay constant in a memory location until all of an input feature map's data is provided to a core and the corresponding outputs have been computed by the core. The outputs computed during a given phase of computation in the CIM are “partial” outputs (referred to as partial sums) of a computation. The partial sums may be stored and retrieved later, to accumulate with further sets of partial sums of data that will be computed during later phases of the computation. That is, a complete operation may comprise several phases of calculations generating partial sums, retrieval of any previously stored partial sums, accumulation of newly calculated partial sums with any retrieved partial sums and finally, storage of latest (accumulated) partial sums.

A weight stationary data flow avoids the overhead associated with re-loading of weight data during DNN workloads processing. In some examples, such a weight stationary dataflow continuously generates partial sums and may demand additional bandwidth and energy for storage and retrieval of such partial sums from memory that is farther away from a computational element. In cases where the entire input feature map and/or the weight tensor cannot fit in the limited memory size of an IMCC, the computation is handled in phases, wherein part of the input feature maps and/or weights are fed-in to the IMCC, thereby generating partial sums. Doing so increases latency, power and bandwidth.

Examples include a hardware design to handle partial sums to reduce energy, latency, power and bandwidth bottlenecks associated with weight stationary dataflow in IMCC architectures. Examples present an intra-memory data reuse scheme for storing the partial sums during computations of an IMCC core (e.g., a CIM core). The IMCC core may be partitioned to create a first partition for dedicated storage and a second partition to execute operations that generate partial sums. The partial sums may be transferred into and out of the first partition during operations (e.g., multiply—accumulate operation) executed by compute elements in the second partition. Doing so significantly reduces the global memory access bandwidth, as well as the associated read/write power consumption.

For example, the enhanced examples described herein are significantly more energy efficient than existing examples by storing data (e.g., partial sums) in an IMCC core and adopt a weight stationary data flow. By including an internal storage for partial sum within an IMCC core, examples reduce the read and write access energy consumption by significant factors compared to existing hardware. Examples further significantly reduce energy for partial sum data accesses in IMCC architectures with a weight stationary data flow.

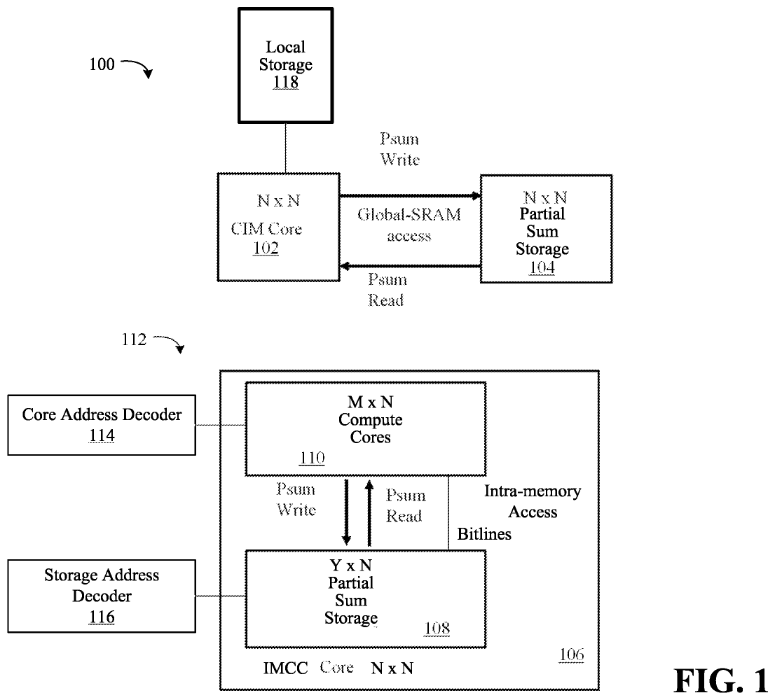

Turning now to FIG. 1, an existing example of a computational system 100 is illustrated. In this example, a CIM core 102 that has N×N (N rows and N columns) computational elements, and an N×N (N rows and N columns) partial sum storage 104. In the partial sum storage 104, a memory bank (e.g., a 1-bit memory bank or memory cell) is disposed at each intersection of a row and column. Thus, the partial sum storage 104 includes N×N memory banks. The CIM core 102 may include only computational elements without significant storage except for registers.

Partial sums are generated in the CIM core 102 during a computational process of a DNN or other machine learning workload. In the existing example, the CIM core 102 generates partial sums with a weight stationary dataflow. The partial sums are written to the partial sum storage 104 (e.g., a global storage), or to a local storage 118 (e.g., static random-access memory (SRAM) arrays). The partial sum storage 104 and the local storage 118 are disposed farther away from the CIM core 102. The read and write accesses of partial sums from the local storage 118 and the partial sum storage 104 may significantly degrade the system level energy efficiency and performance. That is, reading and writing to farther away storages that are off the CIM core 102 result in significant increases in latency, energy, and bandwidth.

That is, dataflow plays a substantial role in determining the performance and energy efficiency during workload execution. Dataflows of DNN workloads comprises choosing a mapping strategy for the inputs and weights of the network onto the CIM core 102.

Turning now to an enhanced IMCC architecture 112, an enhanced architecture is described. The IMCC architecture 112 may reduce the latency, bandwidth, and energy to execute a workload.

In detail, an IMCC core 106 (e.g., a CIM core) includes N×N elements arranged in heterogenous rows and columns. The elements include an M×N compute cores 110 (e.g., includes M×N computational elements) and Y×N partial sum storage 108 (e.g., includes Y×N memory banks). In the IMCC core 106, rather than having all of the N×N elements comprise computational elements, the IMCC core 106 is partitioned between memory and computation. That is, a first partition includes the M×N compute cores 110 and a second partition includes the Y×N partial sum storage 108.

For example, partial sums are stored locally inside the IMCC core 106 during execution of the workload (e.g., a weight stationary data flow), by partitioning the core for compute and data storage. Thus, the IMCC core 106 is capable of locally providing both compute operations and data storge. For example, a memory array that comprises for example N rows×N columns into two sub-arrays using bitline isolation processes associated with bitlines (described below). In this example M may be greater than Y by some factor (e.g., four times). Further, a summation of M and Y is equal to N.

As shown, a core address decoder 114 and storage address decoder 116 are provided. The core address decoder 114 may identify which of the compute cores 110 are to receive data from the partial sum storage 108 and/or execute particular operations. The storage address decoder 116 identifies storage locations of data within the partial sum storage 108. For example the storage address decoder 116 may identify which storage location(s) of the partial sum storage 108 store partial sum data associated with a particular computation (e.g., for accumulation to determine final output determination). The storage location(s) may be accessed, the partial sum data retrieved and provided to corresponding ones of the compute cores 110 (e.g., thought Psum write operations and Psum read operations). The core address decoder 114 may identify the corresponding ones of the compute cores 110. In some examples, partial sums stored in the partial sum storage 108 are accumulated together to generate a final output.

Thus, as illustrated, the partial sum data is stored locally on the IMCC core 106 rather than on a memory that is farther away from the IMCC core 106. Thus, the partial sum writes (Psum write) and partial sum reads (Psum read) may be executed with greater efficiency, less latency and less energy relative to the computational system 100.

Thus, examples include an intra-memory data reuse scheme for storing the partial sums locally within the IMCC core 106. The IMCC core 106 may be partitioned to execute MAC operations to generate partial sum data in a first partition. The IMCC core 106 may be further partitioned to create a second partition for storing the partial sum data into the partial sum storage 108 such that the partial sum data may move to and from the partial sum storage 108 during the MAC operations in the second partition. Doing so significantly reduces the global memory access bandwidth requirement and the associated read and/or write power consumption. In some examples, a separate partial sum storage, similar to partial sum storage 104, and local storage, similar to the local storage 118, may be provided.

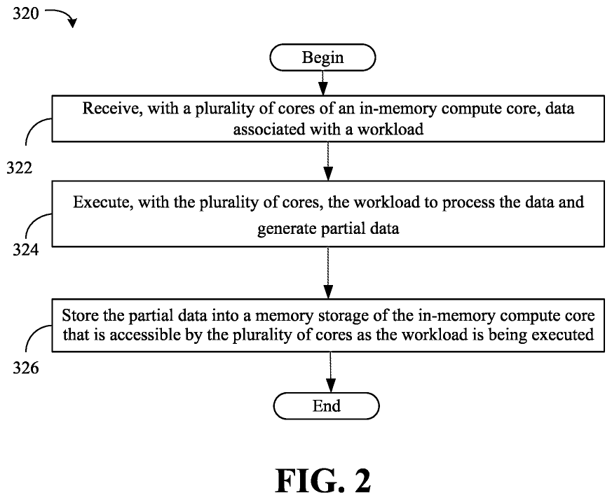

FIG. 2 shows a method 320 of operating an IMCC according to embodiments herein. The method 320 may generally be implemented with the embodiments described herein, for example, the enhanced IMCC architecture (FIG. 1) already discussed. More particularly, the method 320 may be implemented in one or more modules as a set of logic instructions stored in a machine-or computer-readable storage medium such as random access memory (RAM), read only memory (ROM), programmable ROM (PROM), firmware, flash memory, etc., in hardware, or any combination thereof. For example, hardware implementations may include configurable logic, fixed-functionality logic, or any combination thereof. Examples of configurable logic include suitably configured programmable logic arrays (PLAs), field programmable gate arrays (FPGAs), complex programmable logic devices (CPLDs), and general purpose microprocessors. Examples of fixed-functionality logic include suitably configured application specific integrated circuits (ASICs), general purpose microprocessor or combinational logic circuits, and sequential logic circuits or any combination thereof. The configurable or fixed-functionality logic can be implemented with complementary metal oxide semiconductor (CMOS) logic circuits, transistor-transistor logic (TTL) logic circuits, or other circuits.

For example, computer program code to carry out operations shown in the method 320 may be written in any combination of one or more programming languages, including an object-oriented programming language such as JAVA, SMALLTALK, C++ or the like and conventional procedural programming languages, such as the “C” programming language or similar programming languages. Additionally, logic instructions might include assembler instructions, instruction set architecture (ISA) instructions, machine instructions, machine dependent instructions, microcode, state-setting data, configuration data for integrated circuitry, state information that personalizes electronic circuitry and/or other structural components that are native to hardware (e.g., host processor, central processing unit/CPU, microcontroller, etc.).

Illustrated processing block 322 receives, with a plurality of cores of an in-memory compute core, data associated with a workload. Illustrated processing block 324 executes, with the plurality of cores, the workload to process the data and generate partial data. Illustrated processing block 326 stores the partial data into a memory storage of the in-memory compute core that is accessible by the plurality of cores as the workload is being executed. In some embodiments, the in-memory compute core is a single compute-in-memory core. In some embodiments, the plurality of cores receives the partial data from the memory storage during execution of the workload.

In some embodiments, the method 320 further includes controlling, with control logic implemented in one or more of configurable logic or fixed-functionality logic, storage of the partial data into the memory storage and accesses of the partial data stored in the memory storage. In some embodiments, the method 320 includes selecting, with control logic implemented in one or more of configurable logic or fixed-functionality logic, one or more of the plurality of cores to execute the workload. In some embodiments, the workload is associated with a machine learning model and includes a multiply—accumulate operation, and the plurality of cores and memory banks of the memory storage are arranged in heterogeneous columns and rows.

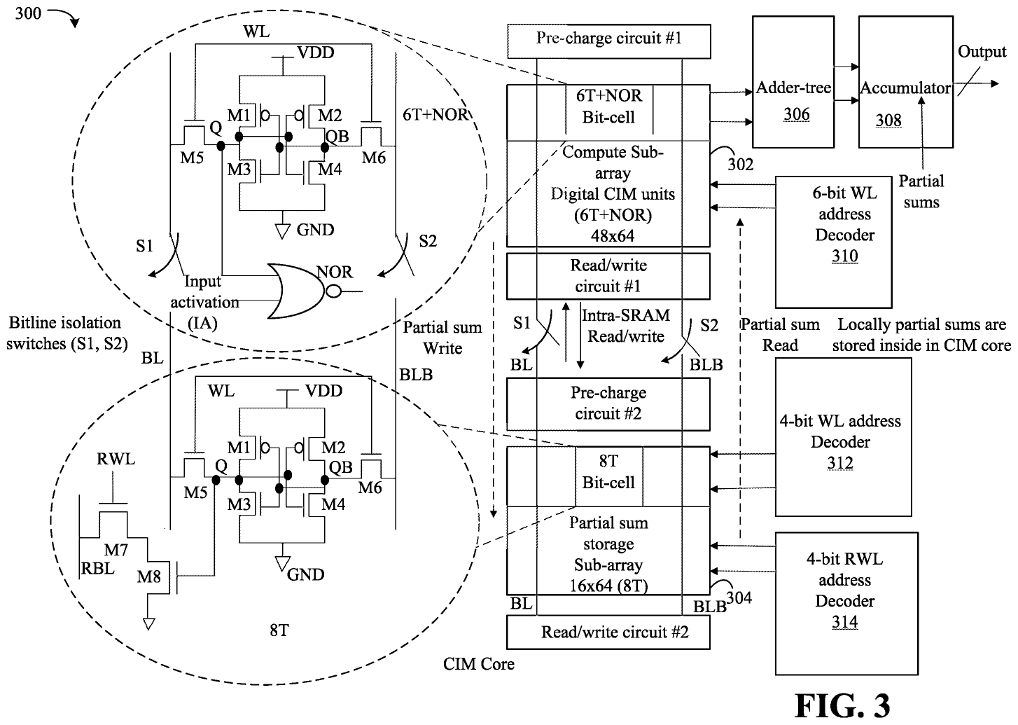

FIG. 3 illustrates a detailed circuit diagram of local storage of partial sums inside an IMCC 300. The IMCC 300 may generally be implemented with the embodiments described herein, for example, the enhanced IMCC architecture 112 (FIG. 1) and/or the method 320 (FIG. 2) already discussed. The IMCC core 300 supports intra-SRAM read and/or write access of partial sums inside the IMCC core 300 through the separate read and/or write peripherals for both compute core and storage core. A compute sub-array includes digital CIM units 302 (e.g., compute cores) that execute computations. A partial sum storage sub-array 304 (e.g., a partial sum storage) stores partial sums for the digital CIM units 302 (which may also be referred to as IMC units). The compute cores of the digital CIM units 302 may be comprised of 6T-SRAM (six transistor memory) cells, while the partial sum storage sub-array 304 may be comprised of 8T-SRAM (eight transistor memory) cells. 8T-SRAM cells provide separate read and write ports, allowing simultaneous read and write operations to non-overlapping addresses. Thus, by using 8T-SRAM based the partial sum storage sub-array 304, examples provide simultaneous partials storage and retrieval capability, thus significantly enhancing the partial data access bandwidth, which may not be possible if using an external storage. Even if such an external storage were also made of 8T SRAM, current examples still save energy by placing the partial sum storage sub-array 304 within the IMCC core 300.

During different phases of a workload, the digital CIM units 302 may generate partial sums. The partial sums are stored into the partial sum storage sub-array 304 until the phases are complete. Thereafter, the digital CIM units 302 may provide the partial sums from the partial sum storage sub-array 304 to an adder tree 306. The adder tree 306 generates the current output (e.g., partials) from the digital CIM units 302. The current partials and previous partials retrieved from partial sum storage sub-array 304 are provided to the accumulator 308, where the current partials and previous partials are summed-up to generate the accumulated output.

A 6-bit WL address decoder 310 may control selection of CIM units of the compute digital CIM units 302 to execute workloads. A 4-bit WL address decoder 312 may control accesses to the 8T bit-cell, and a 4-bit RWL address decoder 314 controls accesses to the partial sum storage sub-array 304. Both the 4-bit WL address decoder 312 and the 4-bit RWL address decoder 314 are address decoders. The partial sum storage sub-array 304 is a storage unit made up of an array of 8T SRAM cells (eight transistor memory cells), which have separate read and write ports. The 4-bit WL address decoder 312 is a write address decoder and 4-bit RWL address decoder 314 is a read address decoder. Both of the 4-bit WL address decoder 312 and 4-bit RWL address decoder 314 may be used simultaneously to access non-overlapping addresses within 304, to perform simultaneous read, write operation on 304.

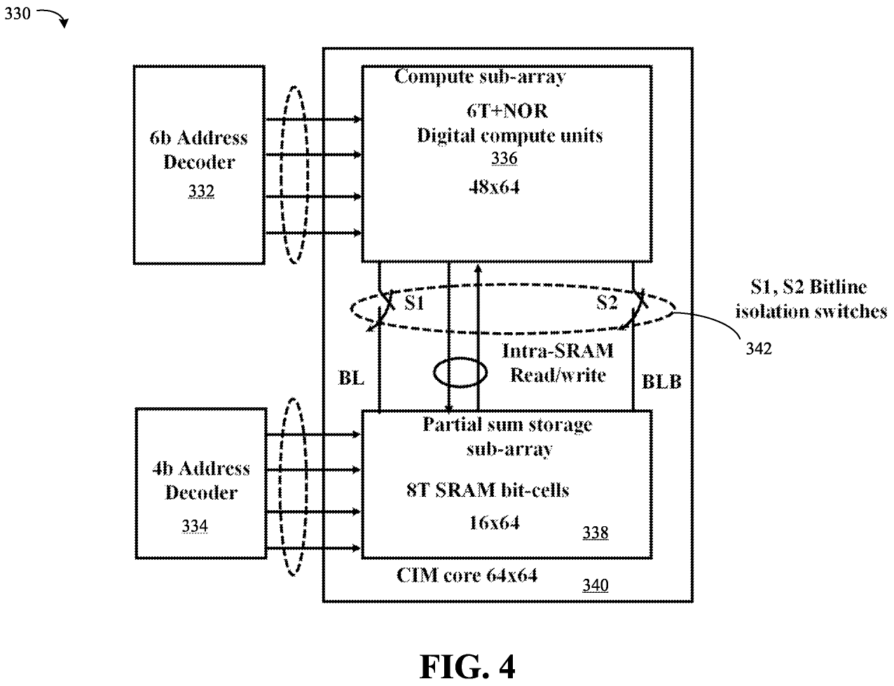

FIG. 4 illustrates a block diagram of an enhanced IMCC 330 to handle partial sums storage for supporting a weight stationary dataflow. The IMCC 330 may generally be implemented with the embodiments described herein, for example, the enhanced IMCC architecture 112 (FIG. 1), the method 320 (FIG. 2) and/or IMCC 300 (FIG. 3) already discussed.

Bitline isolation is performed with transmission gate switches 342. The upper SRAM sub-array (48 rows×64 columns) contains digital compute units 336 (e.g., CIM bitcells including 6T+NOR gate) for 1 bit-multiply operations. While elements described herein have associated values for rows and columns, it will be understood that the values may be modified. The lower SRAM sub-array (16 rows×64 columns) is a partial sum storage sub-array 338 that contains standard 8T SRAM bitcells and stores the partial sums.

The 8T SRAM bitcells of the partial sum storage sub-array 338 may have decoupled read and/or write ports to permit reading and/or writing the partial sums simultaneously from two separate rows of a partial sum storage 338. An additional enhancement of the IMCC 330 is that reconnection of the bitlines of the sub-arrays is permitted to use the enhanced digital CIM core 340 as a single 64×64 array for normal data storage purpose. In some examples, the CIM core 340 may be selectively alternated between partial compute units and partial summation storage, and partial summation storage without the partial compute units. The digital compute units 336 may selectively operate as computational units, or memory cells. Similarly, the partial sum storage sub-array 338 may selectively operate as computational units, or memory cells. Each digital compute unit may comprise a 6T SRAM cell (6 transistor memory cell) and a NOR gate. The NOR gate samples 1-bit data of the 6T SRAM cell to perform the 1-bit compute (e.g., one input (weight) to the NOR gate is from the 6T SRAM cell and a second input comes externally from the input feature map). If the NOR gate is disregarded or bypassed, the 6T SRAM cells will still operate within the normal function of writing and reading data. Hence, when the digital compute units 336 are to operate for normal storage purpose, examples may write/read data into the 6T cells of the digital compute units 336 and disregard the outputs of NOR gates of the digital compute units 336. Examples may reduce the frequency of situations where the precision of partial sums is reduced to enable memory storage, thus allowing for higher accuracy accumulation during neural network operations (e.g., MAC). The 6b address decoder 332 and the 4b address decoder 334 may control operations to the digital compute units 336 and the partial sum storage sub-array 338.

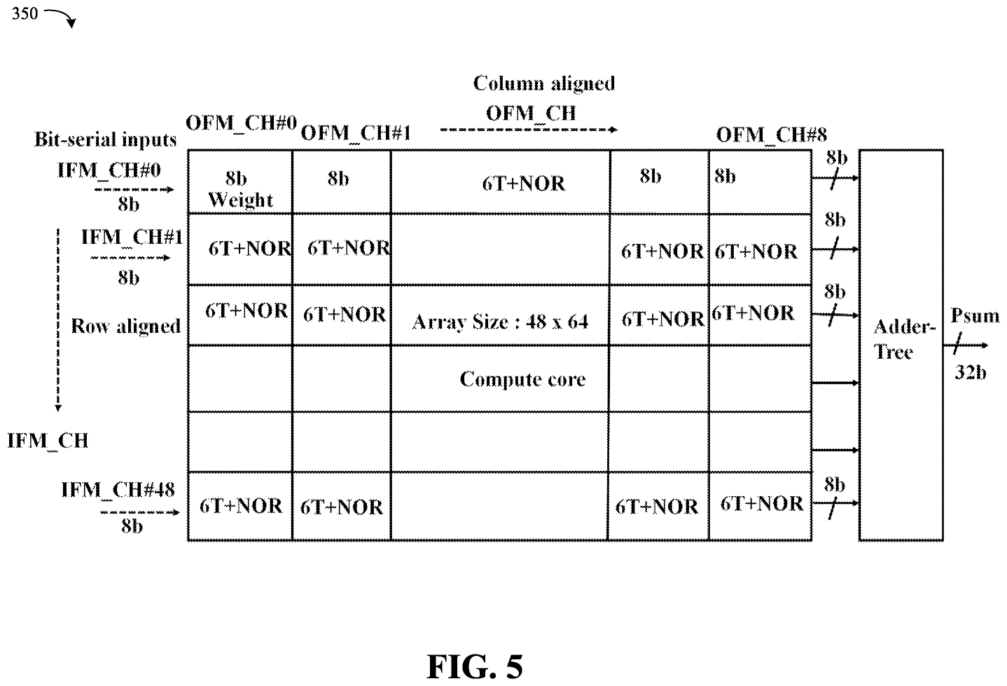

FIG. 5 illustrates a detailed diagram 350 of read/write accesses. The detailed diagram 350 may generally be implemented with the embodiments described herein, for example, the enhanced IMCC architecture 112 (FIG. 1), the method 320 (FIG. 2), IMCC 300 (FIG. 3) and/or IMCC 330 (FIG. 4) already discussed.

Examples operate with intra-SRAM read/write access of partial summations inside the CIM core through separate read and/or write peripherals for both compute cores and storage cores. In some examples, the following data structures may be as follows:
IFM/Weight data bit precision: 8 bits
Partial data bit precision: 32 bits
IFM_CH alignment in the IMC array: Row-aligned
OFM_CH (filters) alignment in the IMC array: Column-aligned
No. of filters handled simultaneously: 64/8=8

The mapping of IFM_CH and OFM_CH in the IMCC array is illustrated in the detailed diagram 350. The 8b filter weights of output channels (filters) (OFM_CH) are stored in (8) consecutive (6T+NOR) SRAM bit-cells in column direction. The CIM core can handle (8) filters simultaneously. The 8b inputs (IFM_CH) are applied in bit-serial fashion along the row direction

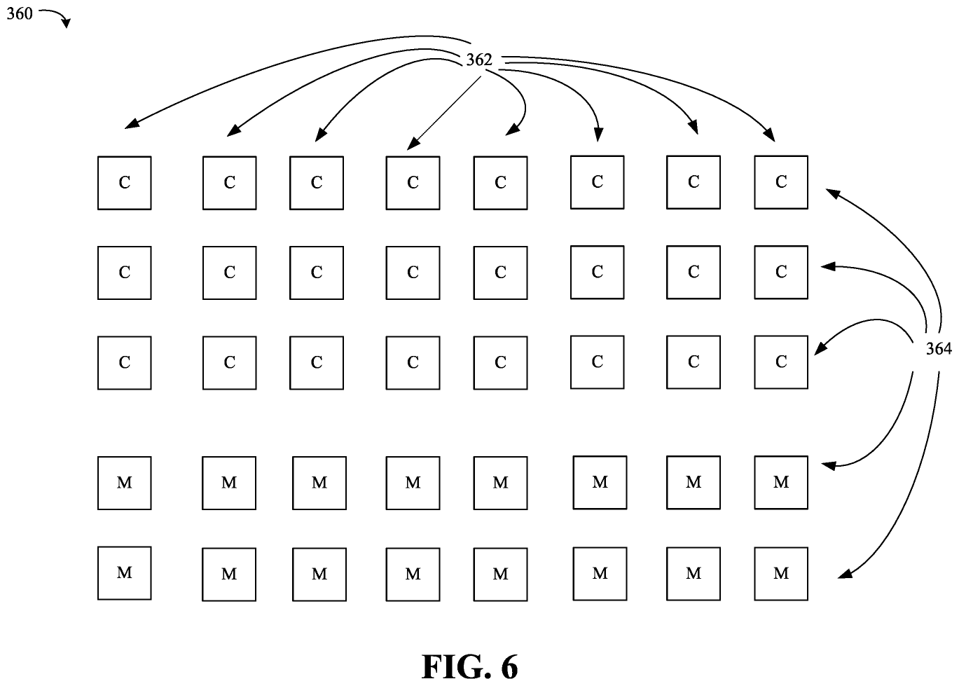

FIG. 6 illustrates an IMCC 360 (e.g., a single IMCC). The IMCC 360 may generally be implemented with the embodiments described herein, for example, the enhanced IMCC architecture 112 (FIG. 1), the method 320 (FIG. 2), IMCC 300 (FIG. 3), IMCC 330 (FIG. 4) and/or detailed diagram 350 (FIG. 5) already discussed. The IMCC 370 includes cores C and memory banks M of a memory storage.

The cores C and memory banks M of the memory storage are arranged in heterogeneous columns 362 and rows 364. For example, each of the columns 362 include heterogenous elements, including a part of the cores C and a part of the memory banks M. In some examples, each of the rows 364 may include a heterogeneous structure to include a part of the cores C and a part of the memory banks M.

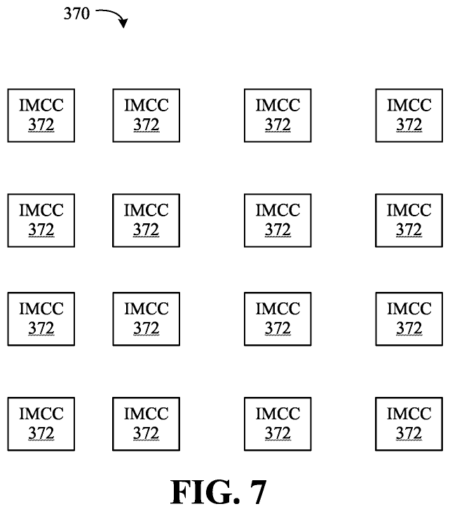

FIG. 7 illustrates a processing array 370 that includes IMCCs 372. The IMCCs 372 may generally be implemented with the embodiments described herein, for example, the enhanced IMCC architecture 112 (FIG. 1), the method 320 (FIG. 2), IMCC 300 (FIG. 3), IMCC 330 (FIG. 4), detailed diagram 350 (FIG. 5) and/or IMCC 370 (FIG. 6) already discussed.

The processing array 370 may generally be implemented with the embodiments described herein, for example, the enhanced IMCC architecture 112 (FIG. 1), the method 320 (FIG. 2), IMCC 300 (FIG. 3), IMCC 330 (FIG. 4) and/or detailed diagram 350 (FIG. 5) already discussed. The IMCCs 372 each include a first partition that includes compute cores and a second partition that includes memory storage. As illustrated, since each respective IMCC of the IMCCs 372 includes storage locally within the respective IMCC, the processing array 370 may bypass inclusion of a global memory separate from the IMCCs 372 and that the IMCCs 372 access to store and retrieve partial sums.

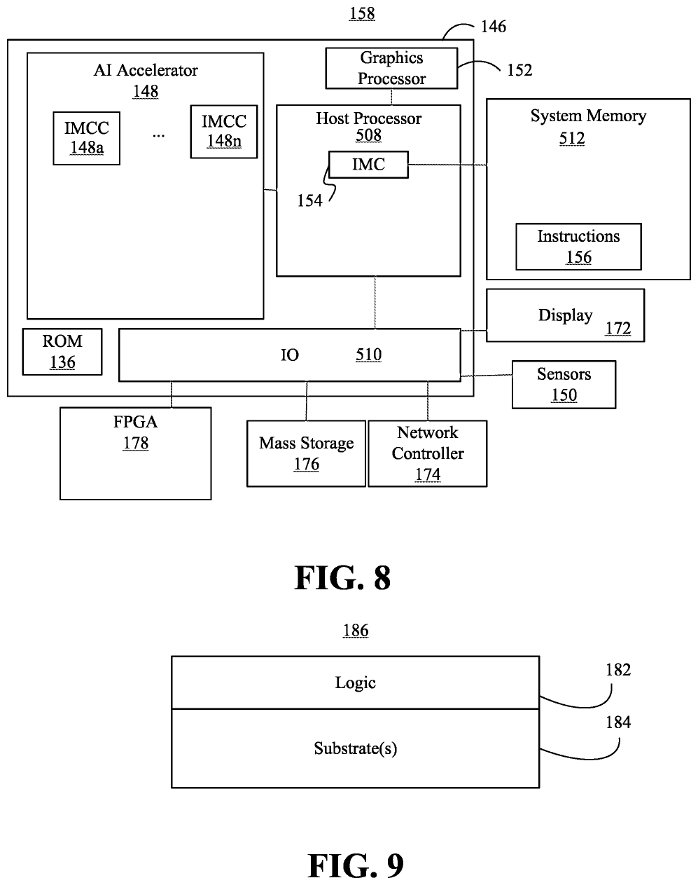

Turning now to FIG. 8, a memory enhanced computing system 158 is shown. The memory enhanced computing system 158 may generally be part of an electronic device/platform having computing functionality (e.g., personal digital assistant/PDA, notebook computer, tablet computer, convertible tablet, server), communications functionality (e.g., smart phone), imaging functionality (e.g., camera, camcorder), media playing functionality (e.g., smart television/TV), wearable functionality (e.g., watch, eyewear, headwear, footwear, jewelry), vehicular functionality (e.g., car, truck, motorcycle), robotic functionality (e.g., autonomous robot, manufacturing robot, autonomous vehicle, industrial robot, etc.), edge device (e.g., mobile phone, desktop, etc.) etc., or any combination thereof. In the illustrated example, the computing system 158 includes a host processor 508 (e.g., CPU) having an integrated memory controller (IMC) 154 that is coupled to a system memory 512.

The illustrated computing system 158 also includes an input output (TO) module 510 implemented together with the host processor 138, the graphics processor 152 (e.g., GPU), ROM 136, and AI accelerator 148 on a semiconductor die 146 as a system on chip (SoC). The illustrated IO module 510 communicates with, for example, a display 172 (e.g., touch screen, liquid crystal display/LCD, light emitting diode/LED display), a network controller 174 (e.g., wired and/or wireless), FPGA 178 and mass storage 176 (e.g., hard disk drive/HDD, optical disk, solid state drive/SSD, flash memory). The IO module 510 also communicates with sensors 150 (e.g., video sensors, audio sensors, proximity sensors, heat sensors, etc.).

The SoC 146 may further include processors (not shown) and/or the AI accelerator 148 dedicated to artificial intelligence (AI) and/or neural network (NN) processing. For example, the system SoC 146 may include vision processing units (VPUs,) and/or other AI/NN-specific processors such as the AI accelerator 148, etc. In some embodiments, any aspect of the embodiments described herein may be implemented in the processors, such as the graphics processor 152 and/or the host processor 508, and in the accelerators dedicated to AI and/or NN processing such as AI accelerator 148 or other devices such as the FPGA 178. In this particular example, the AI accelerator 148 includes IMCCs 148a-148n that may each include a first partition dedicated to compute, and a second partition dedicated to memory storage.

The graphics processor 152, AI accelerator 148 and/or the host processor 508 may execute instructions 156 retrieved from the system memory 512 (e.g., a dynamic random-access memory) and/or the mass storage 176 to implement aspects as described herein. In some examples, when the instructions 156 are executed, the computing system 158 may implement one or more aspects of the embodiments described herein. For example, the computing system 158 may implement one or more aspects of the embodiments described herein, for example, the enhanced IMCC architecture 112 (FIG. 1), the method 320 (FIG. 2), IMCC 300 (FIG. 3), IMCC 330 (FIG. 4), detailed diagram 350 (FIG. 5), IMCC 360 (FIG. 6) and/or IMCCs 372 (FIG. 7) already discussed. The illustrated computing system 158 is therefore considered to be memory and performance-enhanced at least to the extent that the computing system 158 may execute machine learning operations.

FIG. 9 shows a semiconductor apparatus 186 (e.g., chip, die, package). The illustrated apparatus 186 includes one or more substrates 184 (e.g., silicon, sapphire, gallium arsenide) and logic 182 (e.g., transistor array and other integrated circuit/IC components) coupled to the substrate(s) 184. In an embodiment, the apparatus 186 is operated in an application development stage and the logic 182 performs one or more aspects of the embodiments described herein. For example, the apparatus 186 may generally implement the embodiments described herein, for example the enhanced IMCC architecture 112 (FIG. 1), the method 320 (FIG. 2), IMCC 300 (FIG. 3), IMCC 330 (FIG. 4), detailed diagram 350 (FIG. 5), IMCC 360 (FIG. 6) and/or IMCCs 372 (FIG. 7) already discussed. The logic 182 may be implemented at least partly in configurable logic or fixed-functionality hardware logic. In one example, the logic 182 includes transistor channel regions that are positioned (e.g., embedded) within the substrate(s) 184. Thus, the interface between the logic 182 and the substrate(s) 184 may not be an abrupt junction. The logic 182 may also be considered to include an epitaxial layer that is grown on an initial wafer of the substrate(s) 184.

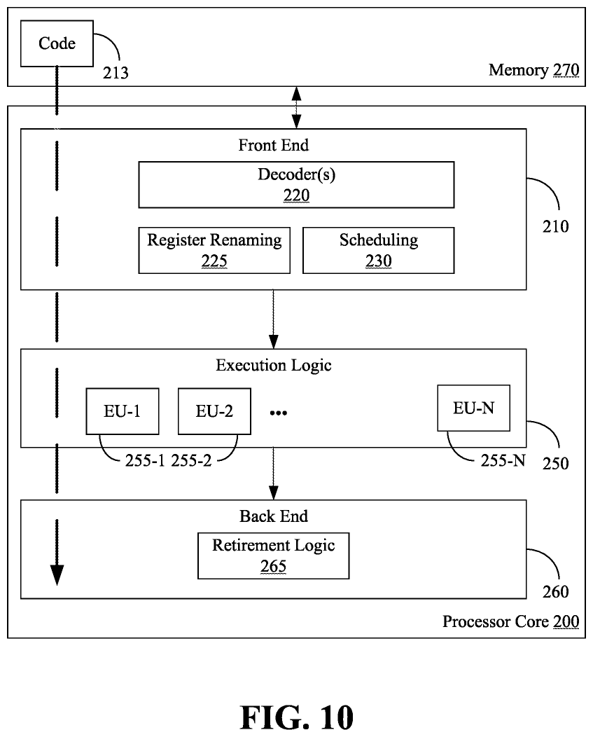

FIG. 10 illustrates a processor core 200 according to one embodiment. The processor core 200 may be the core for any type of processor, such as a micro-processor, an embedded processor, a digital signal processor (DSP), a network processor, or other device to execute code. Although only one processor core 200 is illustrated in FIG. 10, a processing element may alternatively include more than one of the processor core 200 illustrated in FIG. 10. The processor core 200 may be a single-threaded core or, for at least one embodiment, the processor core 200 may be multithreaded in that it may include more than one hardware thread context (or “logical processor”) per core.

FIG. 10 also illustrates a memory 270 coupled to the processor core 200. The memory 270 may be any of a wide variety of memories (including various layers of memory hierarchy) as are known or otherwise available to those of skill in the art. The memory 270 may include one or more code 213 instruction(s) to be executed by the processor core 200, wherein the code 213 may implement one or more aspects of the embodiments such as, for example, the enhanced IMCC architecture 112 (FIG. 1), the method 320 (FIG. 2), IMCC 300 (FIG. 3), IMCC 330 (FIG. 4), detailed diagram 350 (FIG. 5), IMCC 360 (FIG. 6) and/or IMCCs 372 (FIG. 7) already discussed. The processor core 200 follows a program sequence of instructions indicated by the code 213. Each instruction may enter a front end portion 210 and be processed by one or more decoders 220. The decoder 220 may generate as its output a micro operation such as a fixed width micro operation in a predefined format, or may generate other instructions, microinstructions, or control signals which reflect the original code instruction. The illustrated front end portion 210 also includes register renaming logic 225 and scheduling logic 230, which generally allocate resources and queue the operation corresponding to the convert instruction for execution.

The processor core 200 is shown including execution logic 250 having a set of execution units 255-1 through 255-N. Some embodiments may include several execution units dedicated to specific functions or sets of functions. Other embodiments may include only one execution unit or one execution unit that can perform a particular function. The illustrated execution logic 250 performs the operations specified by code instructions.

After completion of execution of the operations specified by the code instructions, back end logic 260 retires the instructions of the code 213. In one embodiment, the processor core 200 allows out of order execution but requires in order retirement of instructions. Retirement logic 265 may take a variety of forms as known to those of skill in the art (e.g., re-order buffers or the like). In this manner, the processor core 200 is transformed during execution of the code 213, at least in terms of the output generated by the decoder, the hardware registers and tables utilized by the register renaming logic 225, and any registers (not shown) modified by the execution logic 250.

Although not illustrated in FIG. 10, a processing element may include other elements on chip with the processor core 200. For example, a processing element may include memory control logic along with the processor core 200. The processing element may include I/O control logic and/or may include I/O control logic integrated with memory control logic. The processing element may also include one or more caches.

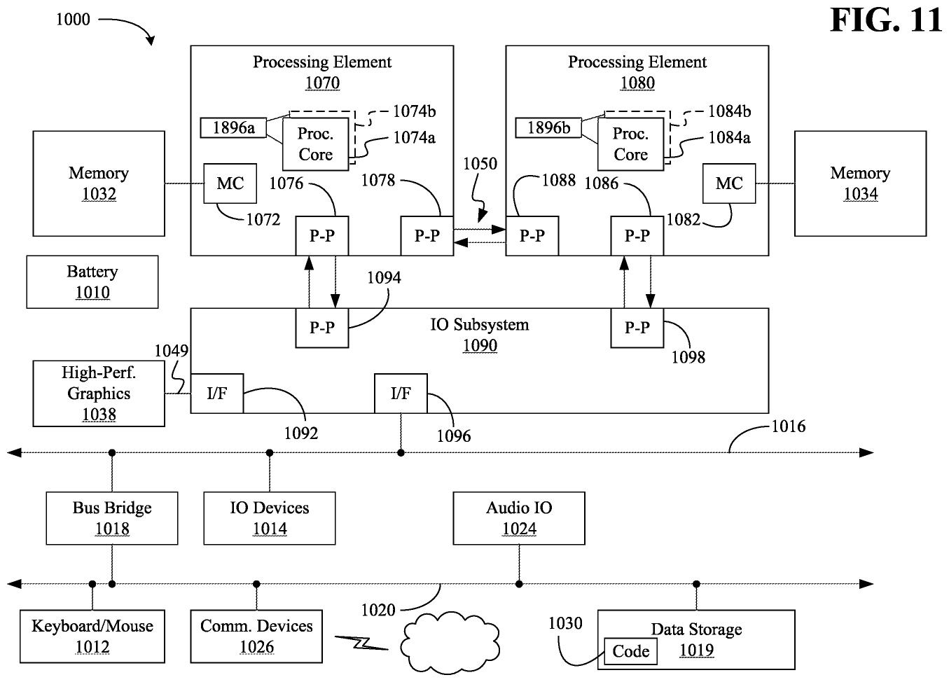

Referring now to FIG. 11, shown is a block diagram of a computing system 1000 embodiment in accordance with an embodiment. Shown in FIG. 11 is a multiprocessor system 1000 that includes a first processing element 1070 and a second processing element 1080. While two processing elements 1070 and 1080 are shown, it is to be understood that an embodiment of the system 1000 may also include only one such processing element.

The system 1000 is illustrated as a point-to-point interconnect system, wherein the first processing element 1070 and the second processing element 1080 are coupled via a point-to-point interconnect 1050. It should be understood any or all the interconnects illustrated in FIG. 11 may be implemented as a multi-drop bus rather than point-to-point interconnect.

As shown in FIG. 11, each of processing elements 1070 and 1080 may be multicore processors, including first and second processor cores (i.e., processor cores 1074a and 1074b and processor cores 1084a and 1084b). Such cores 1074a, 1074b, 1084a, 1084b may be configured to execute instruction code in a manner like that discussed above in connection with FIG. 10.

Each processing element 1070, 1080 may include at least one shared cache 1896a, 1896b. The shared cache 1896a, 1896b may store data (e.g., instructions) that are utilized by one or more components of the processor, such as the cores 1074a, 1074b and 1084a, 1084b, respectively. For example, the shared cache 1896a, 1896b may locally cache data stored in a memory 1032, 1034 for faster access by components of the processor. In one or more embodiments, the shared cache 1896a, 1896b may include one or more mid-level caches, such as level 2 (L2), level 3 (L3), level 4 (L4), or other levels of cache, a last level cache (LLC), and/or combinations thereof.

While shown with only two processing elements 1070, 1080, it is to be understood that the scope of the embodiments is not so limited. In other embodiments, one or more additional processing elements may be present in a given processor. Alternatively, one or more of processing elements 1070, 1080 may be an element other than a processor, such as an accelerator or a field programmable gate array. For example, additional processing element(s) may include additional processors(s) that are the same as a first processor 1070, additional processor(s) that are heterogeneous or asymmetric to processor a first processor 1070, accelerators (such as, e.g., graphics accelerators or digital signal processing (DSP) units), field programmable gate arrays, or any other processing element. There can be a variety of differences between the processing elements 1070, 1080 in terms of a spectrum of metrics of merit including architectural, micro architectural, thermal, power consumption characteristics, and the like. These differences may effectively manifest themselves as asymmetry and heterogeneity amongst the processing elements 1070, 1080. For at least one embodiment, the various processing elements 1070, 1080 may reside in the same die package.

The first processing element 1070 may further include memory controller logic (MC) 1072 and point-to-point (P-P) interfaces 1076 and 1078. Similarly, the second processing element 1080 may include a MC 1082 and P-P interfaces 1086 and 1088. As shown in FIG. 11, MC's 1072 and 1082 couple the processors to respective memories, namely a memory 1032 and a memory 1034, which may be portions of main memory locally attached to the respective processors. While the MC 1072 and 1082 is illustrated as integrated into the processing elements 1070, 1080, for alternative embodiments the MC logic may be discrete logic outside the processing elements 1070, 1080 rather than integrated therein.

The first processing element 1070 and the second processing element 1080 may be coupled to an I/O subsystem 1090 via P-P interconnects 1076 1086, respectively. As shown in FIG. 11, the I/O subsystem 1090 includes P-P interfaces 1094 and 1098. Furthermore, I/O subsystem 1090 includes an interface 1092 to couple I/O subsystem 1090 with a high performance graphics engine 1038. In one embodiment, bus 1049 may be used to couple the graphics engine 1038 to the I/O subsystem 1090. Alternately, a point-to-point interconnect may couple these components.

In turn, I/O subsystem 1090 may be coupled to a first bus 1016 via an interface 1096. In one embodiment, the first bus 1016 may be a Peripheral Component Interconnect (PCI) bus, or a bus such as a PCI Express bus or another third generation I/O interconnect bus, although the scope of the embodiments is not so limited.

As shown in FIG. 11, various I/O devices 1014 (e.g., biometric scanners, speakers, cameras, sensors) may be coupled to the first bus 1016, along with a bus bridge 1018 which may couple the first bus 1016 to a second bus 1020. In one embodiment, the second bus 1020 may be a low pin count (LPC) bus. Various devices may be coupled to the second bus 1020 including, for example, a keyboard/mouse 1012, communication device(s) 1026, and a data storage unit 1019 such as a disk drive or other mass storage device which may include code 1030, in one embodiment. The illustrated code 1030 may implement the one or more aspects of such as, for example, the enhanced IMCC architecture 112 (FIG. 1), the method 320 (FIG. 2), IMCC 300 (FIG. 3), IMCC 330 (FIG. 4), detailed diagram 350 (FIG. 5), IMCC 360 (FIG. 6) and/or IMCCs 372 (FIG. 7) already discussed. Further, an audio I/O 1024 may be coupled to second bus 1020 and a battery 1010 may supply power to the computing system 1000.

Note that other embodiments are contemplated. For example, instead of the point-to-point architecture of FIG. 11, a system may implement a multi-drop bus or another such communication topology. Also, the elements of FIG. 11 may alternatively be partitioned using more or fewer integrated chips than shown in FIG. 11.

### Additional Notes and Examples

Example 1 includes a computing system comprising a data storage to store data associated with a workload, and an in-memory compute core that includes a plurality of cores to receive the data associated with the workload and execute the workload to process the data and generate partial data, and a memory storage to store the partial data, where the memory storage is accessible by the plurality of cores as the workload is being executed.

Example 2 includes the computing system of claim 1, where the in-memory compute core is a single in-memory core.

Example 3 includes the computing system of claim 1, where the plurality of cores and memory banks of the memory storage are arranged in heterogeneous columns and rows.

Example 4 includes the computing system of claim 1, where the plurality of cores is to receive the partial data from the memory storage during execution of the workload.

Example 5 includes the computing system of any one of claims 1 to 4, further comprising control logic, implemented in one or more of configurable logic or fixed-functionality logic, to control storage of the partial data into the memory storage and accesses of the partial data stored in the memory storage.

Example 6 includes the computing system of any one of claims 1 to 5, further comprising control logic, implemented in one or more of configurable logic or fixed-functionality logic, to select one or more of the plurality of cores to execute the workload.

Example 7 includes the computing system of any one of claims 1 to 6, where the workload is associated with a machine learning model.

Example 8 includes an in-memory compute core, the in-memory compute core comprising a plurality of cores, implemented in one or more of configurable logic or fixed-functionality logic, to receive data associated with a workload, and execute the workload to process the data and generate partial data, and a memory storage to store the partial data, where the memory storage is accessible by the plurality of cores as the workload is being executed.

Example 9 includes the in-memory compute core of claim 8, where the in-memory compute core is a single in-memory core.

Example 10 includes the in-memory compute core of claim 8, where the plurality of cores and memory banks of the memory storage are arranged in heterogeneous columns and rows.

Example 11 includes the in-memory compute core of claim 8, where the plurality of cores is to receive the partial data from the memory storage during execution of the workload.

Example 12 includes the in-memory compute core of any one of claims 8 to 11, further comprising control logic, implemented in one or more of configurable logic or fixed-functionality logic, to control storage of the partial data into the memory storage and accesses of the partial data stored in the memory storage.

Example 13 includes the in-memory compute core of any one of claims 8 to 12, further comprising control logic, implemented in one or more of configurable logic or fixed-functionality logic, to select one or more of the plurality of cores to execute the workload.

Example 14 includes the in-memory compute core of any one of claims 8 to 13, where the workload is associated with a machine learning model and includes a multiply— accumulate operation.

Example 15 includes a method comprising receiving, with a plurality of cores of an in-memory compute core, data associated with a workload, executing, with the plurality of cores, the workload to process the data and generate partial data, and storing the partial data into a memory storage of the in-memory compute core that is accessible by the plurality of cores as the workload is being executed.

Example 16 includes the method of claim 15, where the in-memory compute core is a single in-memory core.

Example 17 includes the method of claim 15, where the plurality of cores receives the partial data from the memory storage during execution of the workload.

Example 18 includes the method of any one of claims 15 to 17, where further comprising controlling, with control logic implemented in one or more of configurable logic or fixed-functionality logic, storage of the partial data into the memory storage and accesses of the partial data stored in the memory storage.

Example 19 includes the method of any one of claims 15 to 18, where further comprising selecting, with control logic implemented in one or more of configurable logic or fixed-functionality logic, one or more of the plurality of cores for execution of the workload.

Example 20 includes the method of any one of claims 15 to 19, where the workload is associated with a machine learning model and includes a multiply—accumulate operation, and where the plurality of cores and memory banks of the memory storage are arranged in heterogeneous columns and rows.

Example 21 includes an apparatus comprising means for receiving, with a plurality of cores of an in-memory compute core, data associated with a workload, means for executing, with the plurality of cores, the workload to process the data and generate partial data, and means for storing the partial data into a memory storage of the in-memory compute core that is accessible by the plurality of cores as the workload is being executed.

Example 22 includes the apparatus of claim 21, where the in-memory compute core is a single in-memory core.

Example 23 includes the apparatus of claim 21, further comprising means for receiving, with the plurality of cores, the partial data from the memory storage during execution of the workload.

Example 24 includes the apparatus of any one of claims 21 to 23, further comprising means for controlling, with control logic implemented in one or more of configurable logic or fixed-functionality logic, storage of the partial data into the memory storage and accesses of the partial data stored in the memory storage.

Example 25 includes the apparatus of any one of claims 21 to 24, where further comprising means for selecting, with control logic implemented in one or more of configurable logic or fixed-functionality logic, one or more of the plurality of cores for execution of the workload.

Example 26 includes the apparatus of any one of claims 21 to 26, where the workload is associated with a machine learning model and includes a multiply—accumulate operation, and where the plurality of cores and memory banks of the memory storage are arranged in heterogeneous columns and rows.

Embodiments are applicable for use with all types of semiconductor integrated circuit (“IC”) chips. Examples of these IC chips include but are not limited to processors, controllers, chipset components, programmable logic arrays (PLAs), memory chips, network chips, systems on chip (SoCs), SSD/NAND controller ASICs, and the like. In addition, in some of the drawings, signal conductor lines are represented with lines. Some may be different, to indicate more constituent signal paths, have a number label, to indicate a number of constituent signal paths, and/or have arrows at one or more ends, to indicate primary information flow direction. This, however, should not be construed in a limiting manner. Rather, such added detail may be used in connection with one or more exemplary embodiments to facilitate easier understanding of a circuit. Any represented signal lines, whether or not having additional information, may actually comprise one or more signals that may travel in multiple directions and may be implemented with any suitable type of signal scheme, e.g., digital or analog lines implemented with differential pairs, optical fiber lines, and/or single-ended lines.

Example sizes/models/values/ranges may have been given, although embodiments are not limited to the same. As manufacturing techniques (e.g., photolithography) mature over time, it is expected that devices of smaller size could be manufactured. In addition, well known power/ground connections to IC chips and other components may or may not be shown within the figures, for simplicity of illustration and discussion, and so as not to obscure certain aspects of the embodiments. Further, arrangements may be shown in block diagram form in order to avoid obscuring embodiments, and also in view of the fact that specifics with respect to implementation of such block diagram arrangements are highly dependent upon the platform within which the embodiment is to be implemented, i.e., such specifics should be well within purview of one skilled in the art. Where specific details (e.g., circuits) are set forth in order to describe example embodiments, it should be apparent to one skilled in the art that embodiments can be practiced without, or with variation of, these specific details. The description is thus to be regarded as illustrative instead of limiting.

The term “coupled” may be used herein to refer to any type of relationship, direct or indirect, between the components in question, and may apply to electrical, mechanical, fluid, optical, electromagnetic, electromechanical, or other connections. In addition, the terms “first”, “second”, etc. may be used herein only to facilitate discussion, and carry no particular temporal or chronological significance unless otherwise indicated.

As used in this application and in the claims, a list of items joined by the term “one or more of” may mean any combination of the listed terms. For example, the phrases “one or more of A, B or C” may mean A, B, C; A and B; A and C; B and C; or A, B and C.

Those skilled in the art will appreciate from the foregoing description that the broad techniques of the embodiments can be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

We claim:

1. A computing system comprising:
a data storage to store data associated with a workload; and
an in-memory compute core that includes:
a plurality of cores to receive the data associated with the workload and execute the workload to process the data and generate partial data, and
a memory storage to store the partial data, wherein the memory storage is accessible by the plurality of cores as the workload is being executed.

2. The computing system of claim 1, wherein the in-memory compute core is a single in-memory core.

3. The computing system of claim 1, wherein the plurality of cores and memory banks of the memory storage are arranged in heterogeneous columns and rows.

4. The computing system of claim 1, wherein the plurality of cores is to receive the partial data from the memory storage during execution of the workload.

5. The computing system of claim 1, further comprising control logic, implemented in one or more of configurable logic or fixed-functionality logic, to control storage of the partial data into the memory storage and accesses of the partial data stored in the memory storage.

6. The computing system of claim 1, further comprising control logic, implemented in one or more of configurable logic or fixed-functionality logic, to select one or more of the plurality of cores to execute the workload.

7. The computing system of claim 1, wherein the workload is associated with a machine learning model.

8. An in-memory compute core, the in-memory compute core comprising:
a plurality of cores, implemented in one or more of configurable logic or fixed-functionality logic, to
receive data associated with a workload, and
execute the workload to process the data and generate partial data; and
a memory storage to store the partial data, wherein the memory storage is accessible by the plurality of cores as the workload is being executed.

9. The in-memory compute core of claim 8, wherein the in-memory compute core is a single in-memory core.

10. The in-memory compute core of claim 8, wherein the plurality of cores and memory banks of the memory storage are arranged in heterogeneous columns and rows.

11. The in-memory compute core of claim 8, wherein the plurality of cores is to receive the partial data from the memory storage during execution of the workload.

12. The in-memory compute core of claim 8, further comprising control logic, implemented in one or more of configurable logic or fixed-functionality logic, to control storage of the partial data into the memory storage and accesses of the partial data stored in the memory storage.

13. The in-memory compute core of claim 8, further comprising control logic, implemented in one or more of configurable logic or fixed-functionality logic, to select one or more of the plurality of cores to execute the workload.

14. The in-memory compute core of claim 8, wherein the workload is associated with a machine learning model and includes a multiply—accumulate operation.

15. A method comprising:
receiving, with a plurality of cores of an in-memory compute core, data associated with a workload;
executing, with the plurality of cores, the workload to process the data and generate partial data; and
storing the partial data into a memory storage of the in-memory compute core that is accessible by the plurality of cores as the workload is being executed.

16. The method of claim 15, wherein the in-memory compute core is a single in-memory core.

17. The method of claim 15, further comprising receiving, with the plurality of cores, the partial data from the memory storage during execution of the workload.

18. The method of claim 15, wherein further comprising controlling, with control logic implemented in one or more of configurable logic or fixed-functionality logic, storage of the partial data into the memory storage and accesses of the partial data stored in the memory storage.

19. The method of claim 15, further comprising selecting, with control logic implemented in one or more of configurable logic or fixed-functionality logic, one or more of the plurality of cores for execution of the workload.

20. The method of claim 15, wherein:
the workload is associated with a machine learning model and includes a multiply— accumulate operation, and
wherein the plurality of cores and memory banks of the memory storage are arranged in heterogeneous columns and rows.
